(19) United States
(12) Patent Application Publication
(10) Pub. No.: US 2003/0101433 A1
(43) Pub. Date: May 29, 2003

(54) Method and apparatus for providing an iteration operator for an object instance in a dynamically typed language

(76) Inventor: David S. Allison, San Ramon, CA (US)

Correspondence Address: ROSENTHAL & OSHA L.L.P. / SUN, 1221 MCKINNEY, SUITE 2800, HOUSTON, TX, 77010, US

(21) Appl. No.: 09/977,521

(22) Filed: Oct. 12, 2001

(51) Int. Cl. G06F 9/44

(52) U.S. Cl. 717/116; 717/114

(57) ABSTRACT

Embodiments of the present invention are directed to a method and apparatus for providing an iteration operator for an object instance in a dynamically typed language. In one embodiment, a class provides a special operator which produces values which can be iterated through. In one embodiment, a class provides a foreach operator. When the foreach operator is called for an instance of a class, a list of values are returned. In one embodiment, when a foreach statement encounters an instance of a class where the statement expects a list of values to iterate through, the statement calls the foreach operator of the class and iterates through the returned values. In one embodiment, a class provides a special operator which defines how an instance of the class is incremented. In another embodiment, a class provides a special operator which defines how an instance of the class is decremented.

### BACKGROUND OF THE INVENTION

1. Field of the Invention

The present invention relates to the field of computer programming languages, and in particular to a method and apparatus for providing an iteration operator for an object instance in a dynamically typed language.

Sun, Sun Microsystems, the Sun logo, Solaris and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

2. BACKGROUND ART

In some computer programs, it is desirable to iterate through a set of values and perform an operation. Typically, the values are provided by a vector of a known type. However, in a dynamically typed programming language, the type is not known until execution of the code. Thus, the iteration process may result in an error when a non-vector value is encountered. This problem can be better understood with a review of iteration in prior art programming languages.

Iteration in Prior Art Programming Languages

In some programming languages, a “for” statement is used to iteratively set a variable equal to a set of values. For example, in C and C++, the for statement has the following syntax:

for (expression1; expression2; expression3) {

body

}

Expression 1 is typically used to initialize a variable that stores the iteratively altered values. Expression 2 is typically a condition statement. If the condition is met, the body, one or more statements of code, is executed. If the condition is not met, the for statement is terminated. Finally, expression 3 is typically used to stipulate how the value stored in the initialized variable is changed.

An example of program code containing a for statement follows below:

int x = 1;
int y = 0;
for (int c = −6; c < 4; c = c + 5) {

x = x + x;
y = c + 1;

}

Before the for statement, integers x and y are set equal to 1 and 0, respectively. In the for statement, an integer, c, is initialized to −6 and incremented by 5 foreach execution of the body. The body consists of a statement assigning the value of x plus x to x and a statement assigning the value of c plus 1 to y. The body is executed as long as c is less than 4. When this code is executed, c is set to −6. Then, it is determined whether c is less than 4. Since c is less than 4, the body is executed. Then, c is set equal to −1 (i.e., c=c+5). Again, it is determined whether c is less than 4. Since c is less than 4, the body is executed. Then, c is set equal to 4. This time, it is determined that c is not less than 4, so the body does not execute and the for statement is complete.

Foreach

In some programming languages, a “foreach” statement is used to iteratively operate on a set of values. In one example, a foreach statement has the following syntax:

foreach variable vector {

body

}

The vector is a list of values. Foreach successive iteration of the foreach statement, the next value in the vector is assigned to the variable and the body is executed. However, for the foreach statement to function correctly, the values supplied to it must be of known type and the statement must be able to iterate through the values.

Errors in Dynamically Typed Programming Languages

In a dynamically typed programming language, the type of a value supplied is unknown until program execution. Thus, the vector value supplied to foreach may be an object rather than a vector. As a result, the program would produce an error message. An example of error generating code involving a foreach statement is below:

var x = new X( );
foreach i x {

y = i;

}

An instance of a class, X, is created and assigned to x. Since the language cannot determine what values of should be placed in variable i from x, it cannot iterate through those values. Thus, an error is generated.

### SUMMARY OF THE INVENTION

Embodiments of the present invention are directed to a method and apparatus for providing an iteration operator for an object instance in a dynamically typed language. In one embodiment of the present invention, a class provides a special operator which produces values which can be iterated through.

In one embodiment, a class provides a foreach operator. When the foreach operator is called for an instance of a class, a list of values are returned. In one embodiment, when a foreach statement encounters an instance of a class where the statement expects a list of values to iterate through, the statement calls the foreach operator of the class and iterates through the returned values. In other embodiments, the special operator is used in conjunction with statements other than foreach.

In one embodiment, a class provides a special operator which defines how an instance of the class is incremented. In another embodiment, a class provides a special operator which defines how an instance of the class is decremented.

### BRIEF DESCRIPTION OF THE DRAWINGS

These and other features, aspects and advantages of the present invention will become better understood with regard to the following description, appended claims and accompanying drawings where:

FIG. 1 is a flow diagram of the process of executing a foreach statement where an instance of a class is supplied where the statement expects a vector of values in accordance with one embodiment of the present invention.

FIG. 2 is a block diagram of a foreach statement with an instance of a class in place of a vector of values.

FIG. 3 is a flow diagram of the process of executing an increment statement in which an instance of a class is being incremented in accordance with one embodiment of the present invention.

FIG. 4 is a block diagram of an increment statement in which an instance of a class is to be incremented.

FIG. 5 is a flow diagram of the process of executing a decrement statement in which an instance of a class is being decremented in accordance with one embodiment of the present invention.

FIG. 6 is a block diagram of a decrement statement in which an instance of a class is to be decremented.

FIG. 7 is a block diagram of a general purpose computer.

### DETAILED DESCRIPTION OF THE INVENTION

The invention is a method and apparatus for providing an iteration operator for an object instance in a dynamically typed language. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Special Operators

In one embodiment of the present invention, a class provides a special operator which produces values which can be iterated through. In one embodiment, a class provides a foreach operator. When the foreach operator is called for an instance of a class, a list of values are returned. In one embodiment, when a foreach statement encounters an instance of a class where the statement expects a list of values to iterate through, the statement calls the foreach operator of the class and iterates through the returned values. In other embodiments, the special operator is used in conjunction with statements other than foreach.

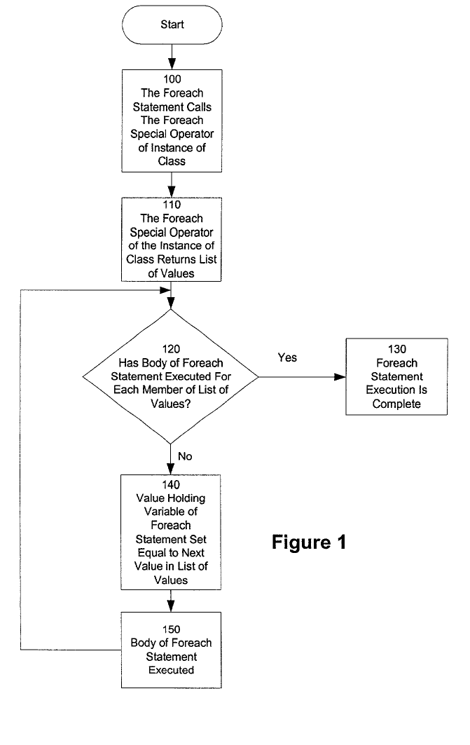

FIG. 1 illustrates the process of executing a foreach statement where an instance of a class is supplied where the statement expects a vector of values in accordance with one embodiment of the present invention. At block 100, the foreach statement calls the foreach special operator of the instance of the class. At block 110, the foreach special operator of the instance of the class returns a list of values.

At block 120, it is determined whether the body of the foreach statement has been executed foreach member of the list of values. If the body of the foreach statement has been executed foreach member of the list of values, at block 130, foreach statement execution is complete. If the body of the foreach statement has not been executed for each member of the list of values, at block 140, the value holding variable of the foreach statement is set equal to the next value in the list of values. At block 150, the body of the foreach statement is executed and the process repeats at block 120.

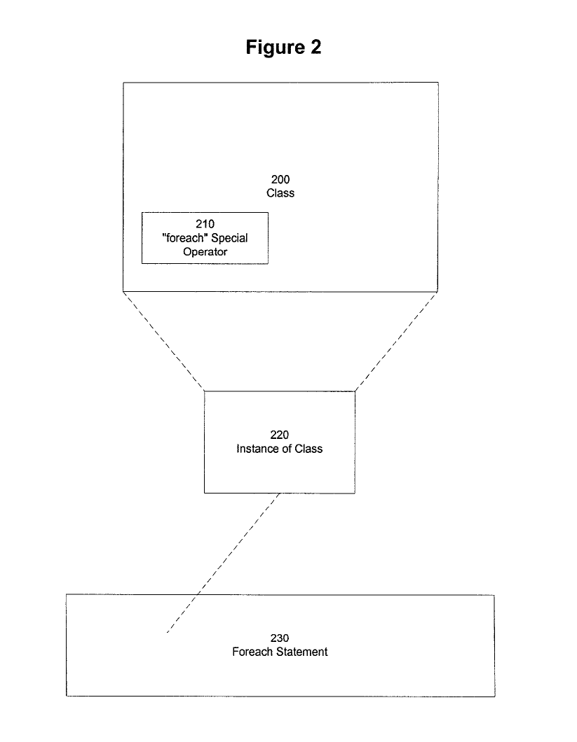

FIG. 2 illustrates a foreach statement with an instance of a class in place of a vector of values. A class 200 is defined which contains a “foreach” special operator 210. An instance 220 of that class is created and is used in a foreach statement 230 where the foreach statement expects a list of values to iterate through. The foreach statement calls the “foreach” special operator of the class for the instance of the class and uses the returned value as the list of values to iterate through.

An example of a class with a foreach special operator in accordance with one embodiment of the present invention appears below:

class X {

var value = [1, 2, 3, 5, 7];
operator foreach( ) {

return value;

}

}

When the foreach special operator is called for an instance of class X, the value stored in “value” is returned. Initially, that value is the list of values, [1, 2, 3, 5, 7]. An example of program code that uses the above class X in a foreach statement is below:

var x = new X( );
foreach i x {

y = i;

}

When the foreach statement executes, the foreach operator of x is called and the value [1, 2, 3, 5, 7] is returned. Then, i is set equal to 1 and the body is executed. Next, i is set equal to 2 and the body is executed. Then, i is set equal to 3 and the body is executed. Next, i is set equal to 5 and the body is executed. Finally, i is set equal to 7 and the body is executed.

Increment Special Operator

In another embodiment, a class provides a special operator which defines how an instance of the class is incremented. An example of a class with an increment special operator in accordance with one embodiment of the present invention appears below:

class X {

var v = 1;
operator ++( ) {

v = v * 2;

}

}

When the increment special operator is called for an instance of class X, the value of v is set to two times the value of v. Thus, if x is and instance of class X and that statement x++ is executed, the increment special operator for x is called. The value stored in member variable v is doubled. It is important to note that any set of instructions may be included in the code for the special operators. For example, in one embodiment the code for the increment special operator sets a variable to one half of its previous value and prints a message to the screen.

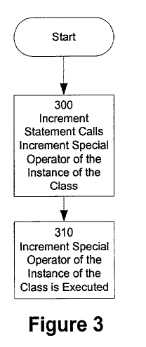

FIG. 3 illustrates the process of executing an increment statement in which an instance of a class is being incremented in accordance with one embodiment of the present invention. At block 300, the increment statement calls the increment special operator of the instance of the class. At block 310, the increment special operator of the instance of the class is executed.

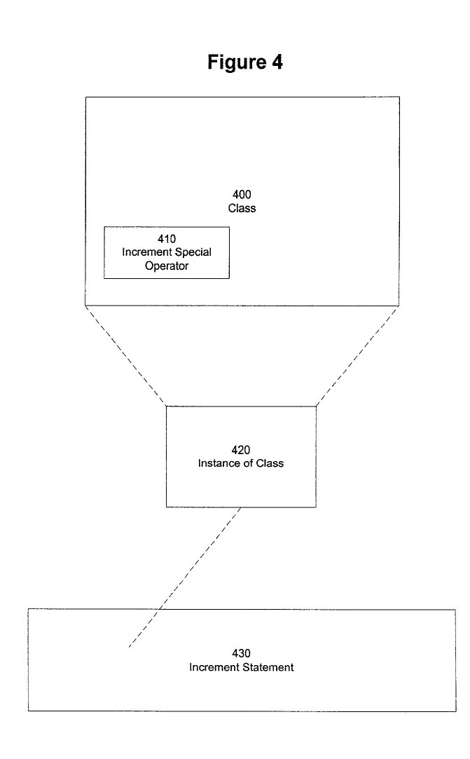

FIG. 4 illustrates an increment statement in which an instance of a class is to be incremented. A class 400 is defined which contains an increment special operator 410. An instance 420 of that class is created and is used in an increment statement 430 in which the instance of the class is to be incremented. The increment statement calls the increment special operator of the class for the instance of the class, and the increment special operator increments the instance of the class.

Decrement Special Operator

In yet another embodiment, a class provides a special operator which defines how an instance of the class is decremented. An example of a class with a decrement special operator in accordance with one embodiment of the present invention appears below:

class X {

var v = 0;
operator --( ) {

v = v − 10;

}

}

When the decrement special operator is called for an instance of class X, the value of v is set to the value of v minus ten. Thus, if x is and instance of class X and that statement x—is executed, the decrement special operator for x is called. The value stored in member variable v becomes v minus 10. In some embodiments, the decrement special operator and the increment special operator will not be inverses of each other. Thus, executing the statement x++ followed by x—may not result in x having the same state as before execution of the two statements.

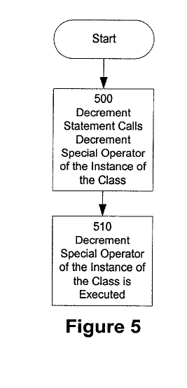

FIG. 5 illustrates the process of executing a decrement statement in which an instance of a class is being decremented in accordance with one embodiment of the present invention. At block 500, the decrement statement calls the decrement special operator of the instance of the class. At block 510, the decrement special operator of the instance of the class is executed.

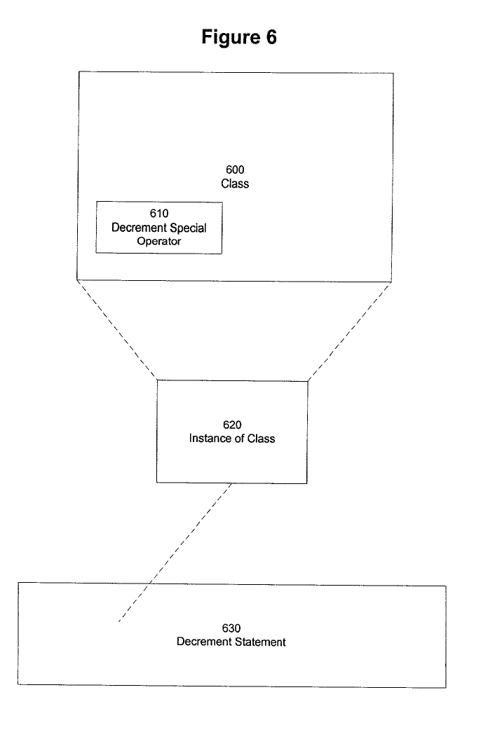

FIG. 6 illustrates a decrement statement in which an instance of a class is to be decremented. A class 600 is defined which contains a decrement special operator 610. An instance 620 of that class is created and is used in a decrement statement 630 in which the instance of the class is to be decremented. The decrement statement calls the decrement special operator of the class for the instance of the class, and the decrement special operator decrements the instance of the class.

Embodiment of Computer Execution Environment (Hardware)

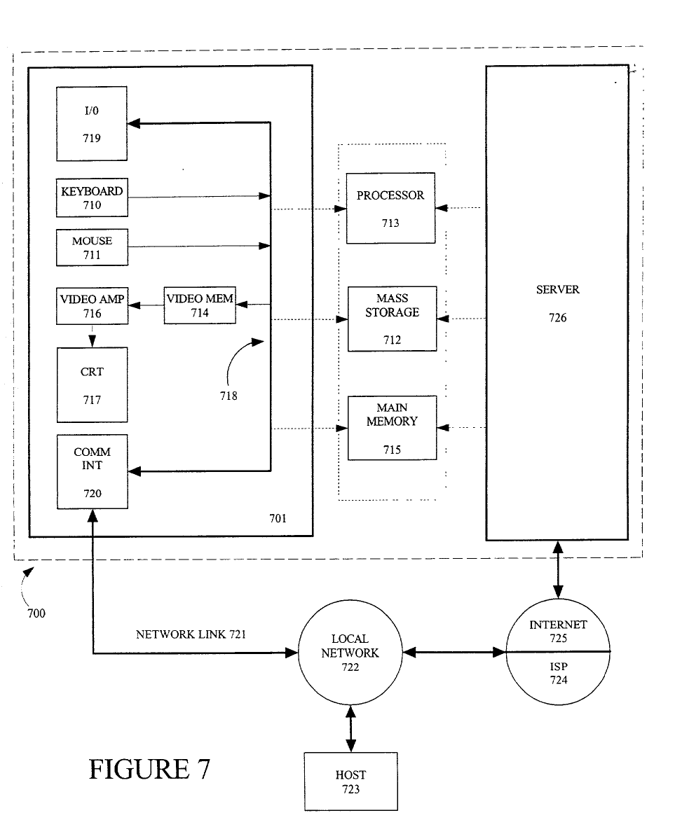

An embodiment of the invention can be implemented as computer software in the form of computer readable program code executed in a general purpose computing environment such as environment 700 illustrated in FIG. 7, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 710 and mouse 711 are coupled to a system bus 718. The keyboard and mouse are for introducing user input to the computer system and communicating that user input to central processing unit (CPU) 713. Other suitable input devices may be used in addition to, or in place of, the mouse 711 and keyboard 710. I/O (input/output) unit 719 coupled to bi-directional system bus 718 represents such I/O elements as a printer, A/V (audio/video) I/O, etc.

Computer 701 may include a communication interface 720 coupled to bus 718. Communication interface 720 provides a two-way data communication coupling via a network link 721 to a local network 722. For example, if communication interface 720 is an integrated services digital network (ISDN) card or a modem, communication interface 720 provides a data communication connection to the corresponding type of telephone line, which comprises part of network link 721. If communication interface 720 is a local area network (LAN) card, communication interface 720 provides a data communication connection via network link 721 to a compatible LAN. Wireless links are also possible. In any such implementation, communication interface 720 sends and receives electrical, electromagnetic or optical signals which carry digital data streams representing various types of information.

Network link 721 typically provides data communication through one or more networks to other data devices. For example, network link 721 may provide a connection through local network 722 to local server computer 723 or to data equipment operated by ISP 724. ISP 724 in turn provides data communication services through the world wide packet data communication network now commonly referred to as the “Internet” 725. Local network 722 and Internet 725 both use electrical, electromagnetic or optical signals which carry digital data streams. The signals through the various networks and the signals on network link 721 and through communication interface 720, which carry the digital data to and from computer 700, are exemplary forms of carrier waves transporting the information.

Processor 713 may reside wholly on client computer 701 or wholly on server 726 or processor 713 may have its computational power distributed between computer 701 and server 726. Server 726 symbolically is represented in FIG. 7 as one unit, but server 726 can also be distributed between multiple “tiers”. In one embodiment, server 726 comprises a middle and back tier where application logic executes in the middle tier and persistent data is obtained in the back tier. In the case where processor 713 resides wholly on server 726, the results of the computations performed by processor 713 are transmitted to computer 701 via Internet 725, Internet Service Provider (ISP) 724, local network 722 and communication interface 720. In this way, computer 701 is able to display the results of the computation to a user in the form of output.

Computer 701 includes a video memory 714, main memory 715 and mass storage 712, all coupled to bi-directional system bus 718 along with keyboard 710, mouse 711 and processor 713. As with processor 713, in various computing environments, main memory 715 and mass storage 712, can reside wholly on server 726 or computer 701, or they may be distributed between the two. Examples of systems where processor 713, main memory 715, and mass storage 712 are distributed between computer 701 and server 726 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 712 may include both fixed and removable media, such as magnetic, optical or magnetic optical storage systems or any other available mass storage technology. Bus 718 may contain, for example, thirty-two address lines for addressing video memory 714 or main memory 715. The system bus 718 also includes, for example, a 32-bit data bus for transferring data between and among the components, such as processor 713, main memory 715, video memory 714 and mass storage 712. Alternatively, multiplex data/address lines may be used instead of separate data and address lines.

In one embodiment of the invention, the processor 713 is a SPARC microprocessor from Sun Microsystems, Inc., a microprocessor manufactured by Motorola, such as the 680×0 processor, or a microprocessor manufactured by Intel, such as the 80×86 or Pentium processor. However, any other suitable microprocessor or microcomputer may be utilized. Main memory 715 is comprised of dynamic random access memory (DRAM). Video memory 714 is a dual-ported video random access memory. One port of the video memory 714 is coupled to video amplifier 716. The video amplifier 716 is used to drive the cathode ray tube (CRT) raster monitor 717. Video amplifier 716 is well known in the art and may be implemented by any suitable apparatus. This circuitry converts pixel data stored in video memory 714 to a raster signal suitable for use by monitor 717. Monitor 717 is a type of monitor suitable for displaying graphic images.

Computer 701 can send messages and receive data, including program code, through the network(s), network link 721, and communication interface 720. In the Internet example, remote server computer 726 might transmit a requested code for an application program through Internet 725, ISP 724, local network 722 and communication interface 720. The received code may be executed by processor 713 as it is received, and/or stored in mass storage 712, or other non-volatile storage for later execution. In this manner, computer 700 may obtain application code in the form of a carrier wave. Alternatively, remote server computer 726 may execute applications using processor 713, and utilize mass storage 712, and/or video memory 715. The results of the execution at server 726 are then transmitted through Internet 725, ISP 724, local network 722 and communication interface 720. In this example, computer 701 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for providing an iteration operator for an object instance in a dynamically typed language is described in conjunction with one or more specific embodiments. The invention is defined by the following claims and their full scope and equivalents.

1. A method for iterating in a dynamically typed programming language comprising:
providing an instance of a class; and
calling a special operator of said class.

2. The method of claim 1 wherein said special operator return a list of values.

3. The method of claim 2 further comprising:
iterating through said list of values.

4. The method of claim 3 wherein said special operator is a foreach operator.

5. The method of claim 1 wherein said special operator is an increment operator.

6. The method of claim 1 wherein said special operator is a decrement operator.

7. A dynamically typed programming language iteration system comprising:
an instance of a class; and
an operator calling unit configured to call a special operator of said class.

8. The dynamically typed programming language iteration system of claim 7 wherein said special operator return a list of values.

9. The dynamically typed programming language iteration system of claim 8 further comprising:
an iteration unit configured to iterate through said list of values.

10. The dynamically typed programming language iteration system of claim 9 wherein said special operator is a foreach operator.

11. The dynamically typed programming language iteration system of claim 7 wherein said special operator is an increment operator.

12. The dynamically typed programming language iteration system of claim 7 wherein said special operator is a decrement operator.

13. A computer program product comprising:
a computer usable medium having computer readable program code embodied therein configured for iterating in a dynamically typed programming language, comprising:
computer readable code configured to cause a computer to provide an instance of a class; and
computer readable code configured to cause a computer to call a special operator of said class.

14. The computer program product of claim 13 wherein said special operator return a list of values.

15. The computer program product of claim 14 further comprising:
computer readable code configured to cause a computer to iterate through said list of values.

16. The computer program product of claim 15 wherein said special operator is a foreach operator.

17. The computer program product of claim 13 wherein said special operator is an increment operator.

18. The computer program product of claim 13 wherein said special operator is a decrement operator.
